(19) United States
(12) Patent Application Publication
(10) Pub. No.: US 2025/0123747 A1
(43) Pub. Date: Apr. 17, 2025

(54) IMPROVED HOST DRAM AND PCIE BANDWIDTH UTILIZATION FOR DRAM-LESS DEVICES

(71) Applicant: Western Digital Technologies, Inc., San Jose, CA (US)

(72) Inventors: Amir SEGEV, Meiter (IL); Shay BENISTY, Beer Sheva (IL); Judah Gamliel HAHN, Ofra (IL)

(73) Assignee: Western Digital Technologies, Inc., San Jose, CA (US)

(21) Appl. No.: 18/488,421

(22) Filed: Oct. 17, 2023

(51) Int. Cl. G06F 3/06

(52) U.S. Cl. CPC G06F 3/061; G06F 3/0655; G06F 3/0673

(57) ABSTRACT

Instead of handing gaming/streaming operations and I/O operations using the same error correction code (ECC) scheme, use a different ECC scheme for different cases. When for gaming/streaming user data cases, ECC is not required, and the protection information (PI) provided by the host is used instead. If the host does not provide the PI for the specific command for gaming/streaming user data, the logic generates and injects ECC transparently to the rest of the logic. For I/O operations the standard ECC scheme will be used, which will include adding cyclic redundancy check (CRC) to the data. Once the CRC is added to the data, the data and the CRC will be encrypted. After a header is added to the data and the CRC all of the information is protected with flash memory unit (FMU) CRC (FMU-CRC).

### BACKGROUND OF THE DISCLOSURE

### Field of the Disclosure

Embodiments of the present disclosure generally relate to improving data protection requirements for user data in read and write commands.

### Description of the Related Art

Some Non-Volatile Memory (NVM) Express (NVMe) devices require dynamic random access memory (DRAM) for multiple cases. One example is Logical to Physical (L2P) tables where L2P translation is required to support address management. DRAM is used to temporarily hold data until the data is written to the memory device (e.g., NAND). DRAM stored user data as write cache. Furthermore, DRAM supports recovery of user data from an error in the memory device (e.g., NAND) during a read operation. When a device predicts data is going to be read by host, the device might pre-fetch the data from the memory device (e.g., NAND).

For gaming/streaming user data, DRAM is also used. DRAM is used when the device knows to expect what data will be required by the graphic processing unit (GPU) to render upcoming game frames. This data might be corrupted, as the affect is a glitch in the picture. Gaming devices might exist in client configurations (console and PC) or in enterprise configurations (cloud gaming servers). Predictive read engines on the host may request game assets for streaming, and these assets can be cached in a Host Memory Buffer (HMB) or somewhere else in host memory.

During multi-functionality requirements, the access time to DRAM is too high to support the required performance metrics, like thousand input/output (I/O) operations per second (KIOPS). As such, a caching mechanism is required. The caching mechanism is used to hold the latency for the random access. However, for the other flows like power-flow, random access is too slow, so a direct memory access (DMA) engine is required as well.

Adding data protection to the user data in the DRAM, will require both extra bandwidth and extra DRAM space, however since not all use cases are the same, there is a need in the art for improving data protection for read and write commands.

### SUMMARY OF THE DISCLOSURE

Instead of handing gaming/streaming operations and I/O operations using the same error correction code (ECC) scheme, use a different ECC scheme for different cases. When for gaming/streaming user data cases, ECC is not required, and the protection information (PI) provided by the host is used instead. If the host does not provide the PI for the specific command for gaming/streaming user data, the logic generates and injects ECC transparently to the rest of the logic. For I/O operations the standard ECC scheme will be used, which will include adding cyclic redundancy check (CRC) to the data. Once the CRC is added to the data, the data and the CRC will be encrypted. After a header is added to the data and the CRC all of the information is protected with flash memory unit (FMU) CRC (FMU-CRC).

In one embodiment, a data storage device comprises: a memory device; and a controller coupled to the memory device, wherein the controller is configured to: configure table ranges and input/output ranges for storage; receive a write request to write data to memory; determine that the write request is for input/output operations; translate the write request into two address ranges, logical block address (LBA) and cyclic redundancy check (CRC); write the LBA to the memory; calculate the CRC; and write the CRC to the memory.

In another embodiment, a data storage device comprises: a memory device; and a controller coupled to the memory device, wherein the controller is configured to: configure table ranges and input/output ranges for storage; receive a write request to write data to memory; determine that the write request is for gaming or streaming operations; translate the write request into a single address range; and write the single address range to the memory, wherein the single address range does not include nonvolatile memory express (NVMe) protection information.

In another embodiment, a data storage device comprises: means to store data; and a controller coupled to the means to store data, wherein the controller is configured to: configure table ranges and input/output ranges for storage; receive a read request to read data from memory; determine that the read request is for input/output operations or gaming/streaming operations; read the data from the memory; and either: calculate a cyclic redundancy check (CRC), compare the calculated CRC to a read CRC, and deliver the read data if the calculated CRC matches the read CRC; or deliver the read data without an error check.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic block diagram illustrating a storage system comprising a DRAM controller, according to one embodiment.

FIG. 3 is a block diagram illustrating shared interface flow, according to certain embodiments.

FIG. 4 is a schematic block diagram illustrating an ECC scheme, according to one embodiment.

FIG. 5 is a schematic diagram illustrating user data and protection information scheme, according to certain embodiments.

FIG. 6 is a schematic diagram illustrating an I/O protection flow, according to certain embodiments.

FIG. 7 is a flowchart illustrating a method for a read request from HMB, according to certain embodiments.

FIG. 8 is a flowchart illustrating a method for a write request to the HMB, according to certain embodiments.

FIG. 9 is a flowchart illustrating a method for a write command and read command for either I/O operations or gaming/streaming operations, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead of handing gaming/streaming operations and I/O operations using the same error correction code (ECC) scheme, use a different ECC scheme for different cases. When for gaming/streaming user data cases, ECC is not required, and the protection information (PI) provided by the host is used instead. If the host does not provide the PI for the specific command for gaming/streaming user data, the logic generates and injects ECC transparently to the rest of the logic. For I/O operations the standard ECC scheme will be used, which will include adding cyclic redundancy check (CRC) to the data. Once the CRC is added to the data, the data and the CRC will be encrypted. After a header is added to the data and the CRC all of the information is protected with flash memory unit (FMU) CRC (FMU-CRC).

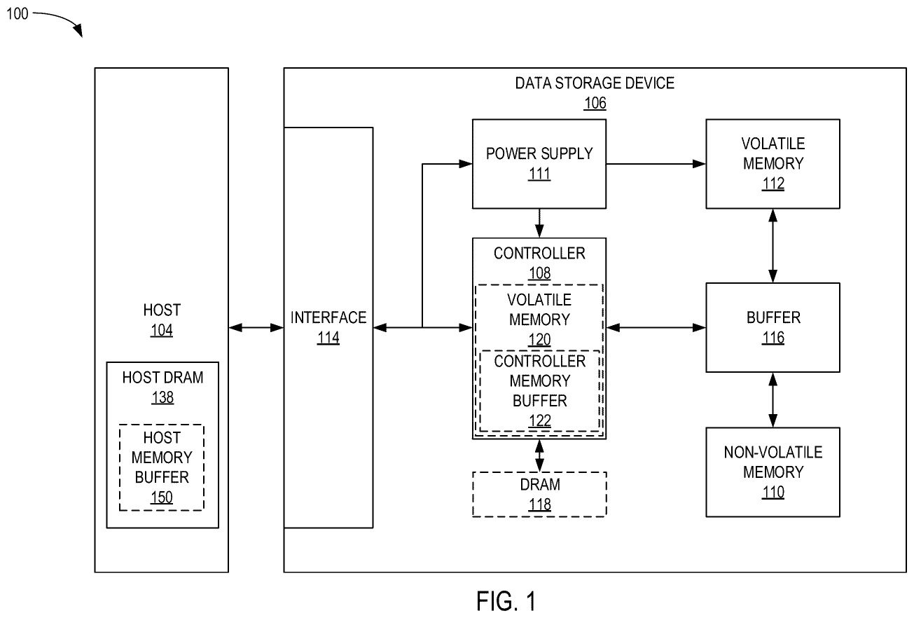

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

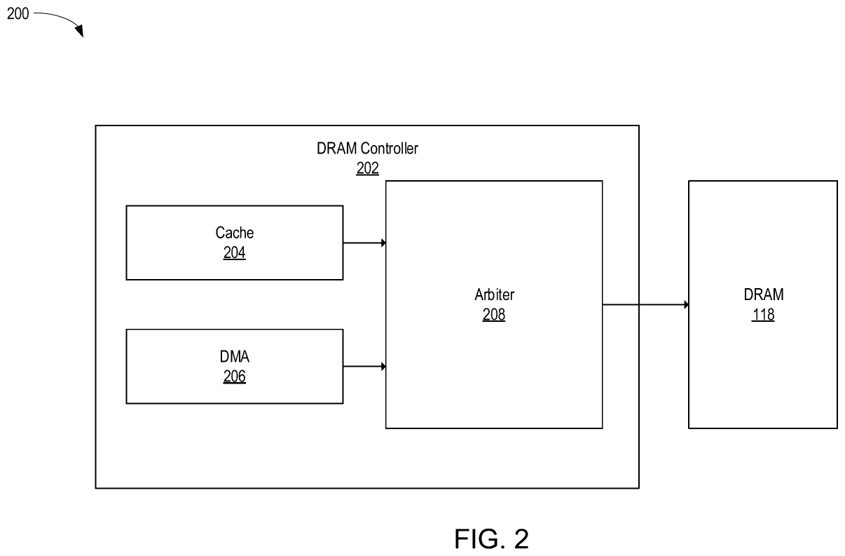

FIG. 2 is a schematic block diagram illustrating storage system 200 comprising a DRAM controller 202, according to one embodiment. The storage system 200 further comprises a DRAM 118. The DRAM controller 202 comprises a cache 204, a DMA 206, and an arbiter 208. The cache 204 is usually for fast random accesses, but gaming user data or user streaming data needs larger non-random memory access. Furthermore, DMAs are the suggested use for gaming and streaming data. In the DRAM controller 202, the arbiter 208 arbitrates between the cache 204 access and the DMA 206 access to the DRAM 118.

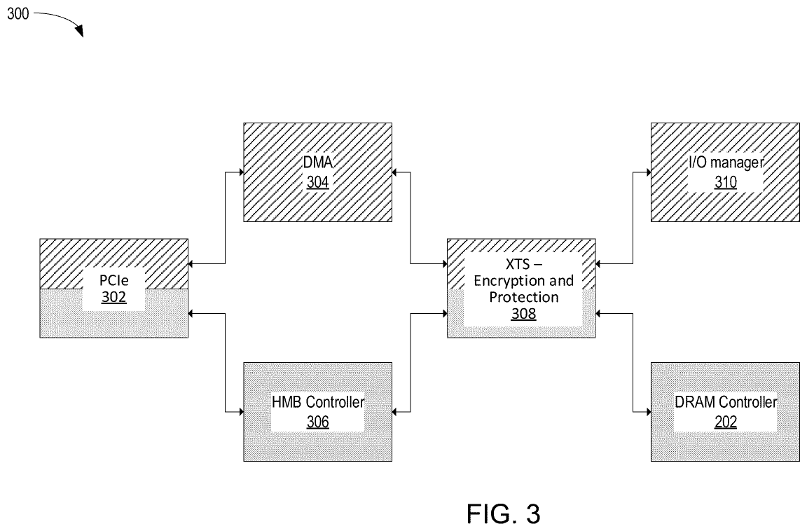

In a DRAM-less device, HMB is used to hold the different structures from FIG. 2. The devices share the same medium (i.e., PCIe) for both host initiated I/O operations and for HMB (i.e., controller initiated traffic). FIG. 3 shows such an example.

FIG. 3 is a block diagram illustrating shared interface flow 300, according to certain embodiments. Devices without local DRAM such as the DRAM 118 uses the HMB such as the HMB 150 of FIG. 1 to hold the different structures as seen in FIG. 2. The shared interface flow 300 has two paths, the bottom path is for the HMB while the top path is for regular I/O operations. The devices share the same PCIe 302 for both host initiated I/O operations (top path), and for the HMB controller 306 initiated traffic (bottom path). FIG. 3 shows a DRAM controller 202 that passes data through an XTS engine (encryption/decryption) 308 to an HMB controller 306, and then to the PCIe 302.

The shared interface flow 300 shows how regular I/O commands are handled through an I/O manager 310. The data also passes through XTS engine (encryption/decryption) 308, but in the data case, also protection information protection information (PI) over NVMe-metadata (MD). The DMA 304 is used to finally pass information to the PCIe 302. The PCIe 302 and the XTS engine (encryption/decryption) 308 are shared by the shared interface.

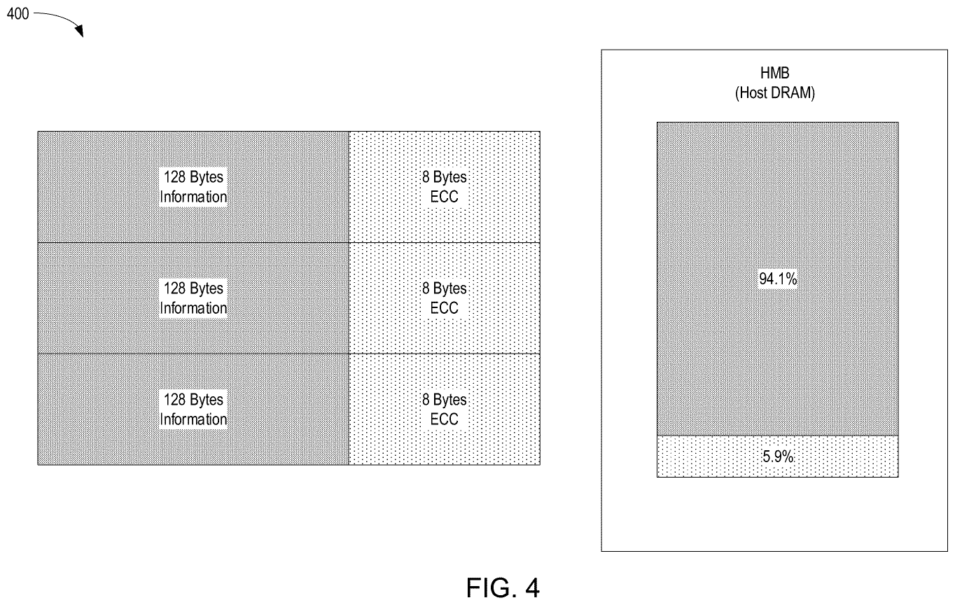

Secure devices encrypt every data that is written externally of the DRAM controller 202, which is why the XTS engine (encryption/decryption) 308 is utilized. The HMB controller 306 is responsible for managing virtual mapping (controller range) to physical mapping (host range) and the error correction code (ECC). For every 128 bytes read, the HMB will also trigger the relevant 8 bytes (as example for number of ECC bytes) read and will check the ECC. For writes, the HMB will generate ECC information. The ECC that is added by the HMB is further explained in FIG. 4.

The most versatile usage for the DRAM such as DRAM 118 of FIG. 1 is as a L2P table. The L2P tables should be accessed for read and write operations. However, during boot, or power modes, the same tables should to be transferred between the memory device (e.g., NAND) and the DRAM quickly. The transfer needs to be quick so the device is able to either turn off power safely or to boot fast. The quick transfer will ensure no bit-flips arise when reading from the DRAM. The reading large portions (power flows) and small portions (random read/writes) together with supporting some ECC protection is shown in the ECC scheme 400.

FIG. 4 is a schematic block diagram illustrating an ECC scheme 400, according to one embodiment. For every 128 bytes of data information, 8 bytes of ECC is provided resulting in around 6% of the HMB (i.e., host DRAM) being used for ECC. It is to be understood that the 6% space used for ECC information is of either local DRAM 118 or host DRAM 138. Furthermore, the traffic effectiveness (i.e., bandwidth) over the PCIe interface is also reduced. The extra ECC bytes complicates the data transfer over the interface since the host DRAM 138 has to work with unaligned data (e.g., instead of 4 KB of data, 4 KB of data plus 32×8B of ECC bytes is needed). Furthermore, the overall performance is reduced since more data should be transferred over the interface (PCIe 302 and DRAM 118).

When using speculative reads for upcoming game assets, even if the data is slightly corrupted, there is no need to correct the data. The effect is minor. As such, the data does not require protection on the host side. In cloud gaming scenarios, enterprise-class devices that support PI may be deployed, while in consoles and PC gaming environments devices will not support PI. Devices that do not support PI will include full internal end-to-end data protection. Speculative reads for gaming environments may use a different read path or priority. Furthermore speculative reads for gaming may be marked in different queues. A way to reduce the 6% overhead in both DRAM and PCIe-bus utilization while simplifying the data transfer and increasing the performance is needed.

As discussed herein, a different ECC scheme is used for different use cases. For user data cases, no ECC is required, and the protection information provided by the host is used instead. If the host does not provide the protection information for the specific command as happens sometimes in client and some gam scenarios, the logic generates and injects protection information transparently to the rest of the logic. For controller information (e.g., L2P tables), the standard ECC scheme will be used.

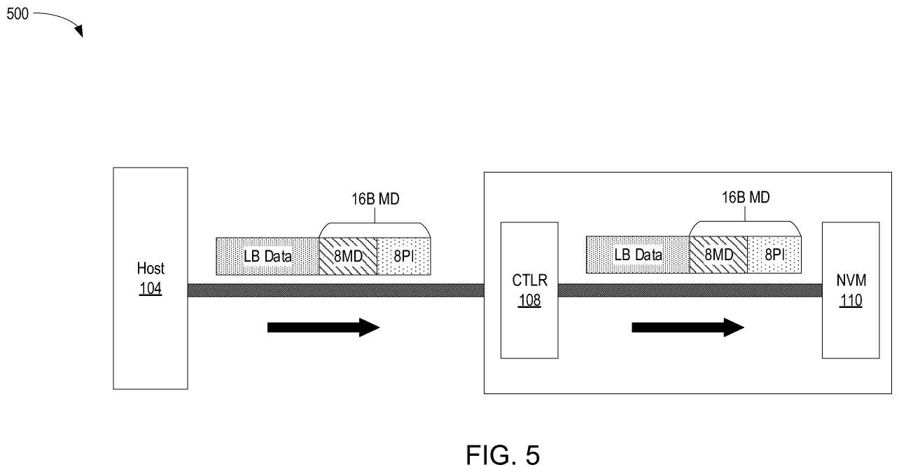

FIG. 5 is a schematic diagram illustrating user data and protection information scheme 500, according to certain embodiments. The NVMe standard defines the protection scheme 500 whenever a device reads/writes logical block (LB) data (user data). The controller 108 receives LB data (i.e., user data), 8 bytes of MD (i.e., metadata) and 8 bytes of PI which is then transferred to the NVM 110. The 8MD and 8PI combined is equal to 16B. The device, such as data storage device 106 of FIG. 1, also should address whatever MD and PI is provided by the host 104. So when the controller, such as the HMB controller 306 of FIG. 3, writes a logical block address (LBA) to the DRAM, such as DRAM 118 of FIG. 1, for read-look-ahead, write-cache, XOR recovery (etc. . . . ), the 4K LBA needs to be written to the memory device (e.g., NAND) together with the 16 bytes of MD plus PI. It is to be understood that though a 4K LBA and a 16 bytes of MD plus PI are mentioned, the values of both the LBA and MD plus PI may be more or less. The host supplied metadata is further increased by local-control information, which is further protected by some CRC mechanism. Use of the protection scheme 500 will decrease the 6% of DRAM 118 used by the ECC information to about 3% ECC information, due to gaming/streaming user data not needing ECC information.

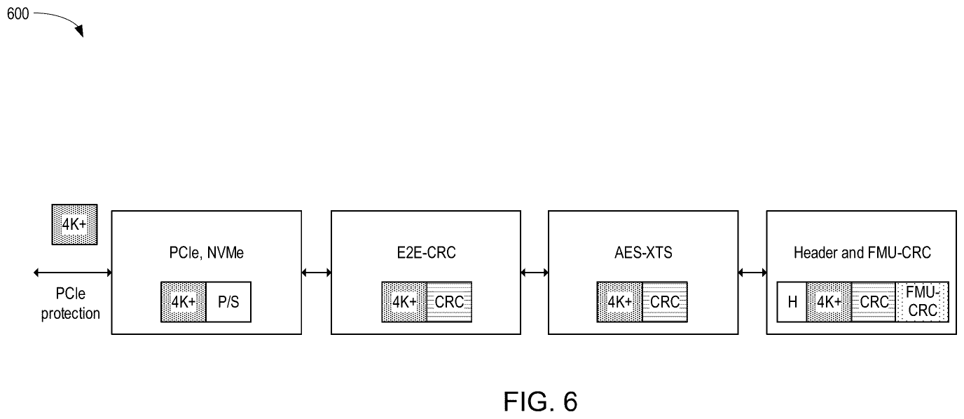

FIG. 6 is a schematic diagram illustrating an input/output (I/O) protection flow 600, according to certain embodiments. The I/O protection flow 600 begins with 4K+ data being moved through the PCIe and NVMe. The 4K+ is the data and the NVMe metadata. The P/S is parity data used to protect the data bus inside the device such as the data storage device 106 of FIG. 1. Since the parity data cannot be moved inside the AES-XTS such as XTS engine (encryption/decryption) 308 of FIG. 3, the P/S is first stripped and replaced with CRC. The CRC is added because the data cannot be protected from bit flip inside the AES-XTS. Later the CRC is encrypted and a header (H) is added with extra control information. Finally, all the data is protected with FMU-CRC.

When FMU-CRC exists, the FMU-CRC can be used by the HMB IP as ECC and save the extra HMB-initiated ECC. When FMU-CRC does not exist, the controller generates and injects the P/S in a transparent way to the rest of the logic. In the read path, the logic transfers the P/S to the host only when required. Otherwise, the logic just verifies and strips the P/S.

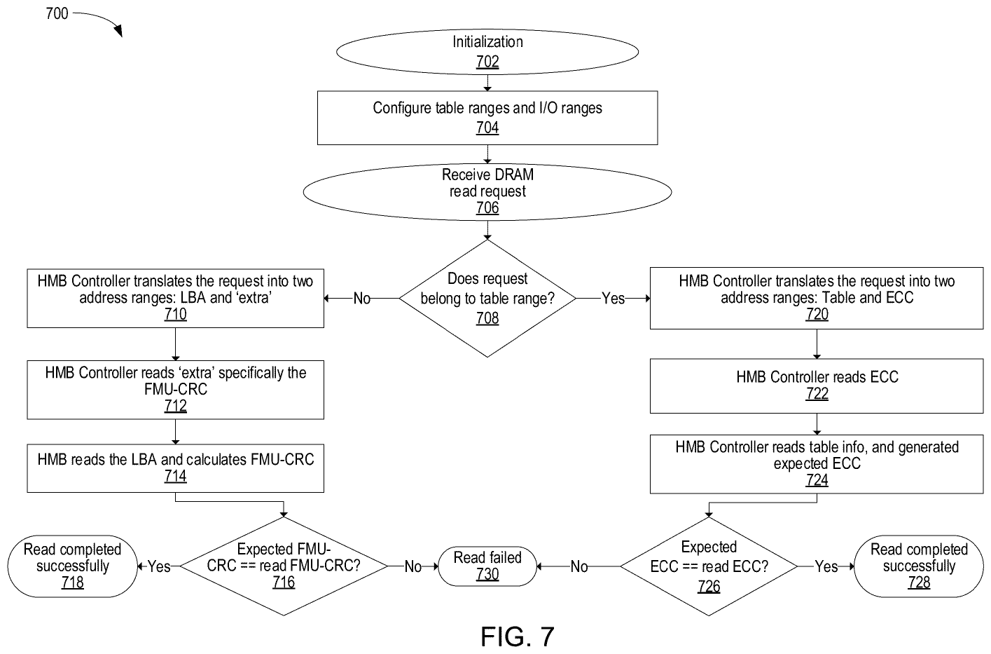

FIG. 7 is a flowchart illustrating a method 700 for a read request from HMB, according to certain embodiments. When reading from HMB, such as HMB 150 of FIG. 1, the entire HMB range is split into areas such as L2P tables, I/O operations for controller information, and gaming/streaming information. While I/O operations use FMU-CRC, the gaming/streaming information does not use FMU-CRC so the gaming/streaming information is not read. The HMB controller will read for either FMU-CRC or ECC in the read requests. At initialization, multiple ranges are defined. Each range is associated as I/O, table or game asset. Later, when a read from HMB arrives, it is classified as a table or as I/O. When a HMB write (i.e., controller to host) is done, all three ranges are considered.

The method 700 begins at block 702. At block 702, initialization beings. At block 704, the HMB controller configures table ranges and I/O ranges. At block 706, the HMB controller receives a DRAM read request. At block 708, the HMB controller determines whether the read request belongs to a table range. If the HMB controller determines that the read request does not belong to a table range, then the method 700 proceeds to block 710. If the HMB controller determines that the read request does belong to a table range, then the method 700 proceeds to block 720.

At block 710, the HMB controller translates the read request into two address ranges: LBA and ‘extra’. At block 712, the HMB controller reads ‘extra’ but specifically the FMU-CRC. At block 714, the HMB controller reads the LBA and calculates the FMU-CRC and, then proceeds to block 716. At block 716, the HMB controller determines whether the expected FMU-CRC is equal to the read FMU-CRC. If the HMB controller determines that the expected FMU-CRC is equal to the read FMU-CRC, then the method 700 proceeds to block 718. If the HMB controller determines that the expected FMU-CRC is not equal to the read FMU-RC, then the method 700 proceeds to block 730. At block 718, the read request is completed successfully. At block 730, the read request is failed.

At block 720, the HMB controller translates the read request into two address ranges: table and ECC. At block 722, the HMB controller reads the ECC. At block 724, the HMB controller reads table information and generated ECC information. At block 726, the HMB controller determines whether the expected ECC is equal to the read ECC. If the HMB controller determines that the expected ECC is equal to the read ECC, then the method 700 proceeds to block 728. If the HMB controller determines that the expected ECC is not equal to the read ECC, then the method 700 proceeds to block 730. At block 728, the read request is completed successfully. At block 730, the read request is failed.

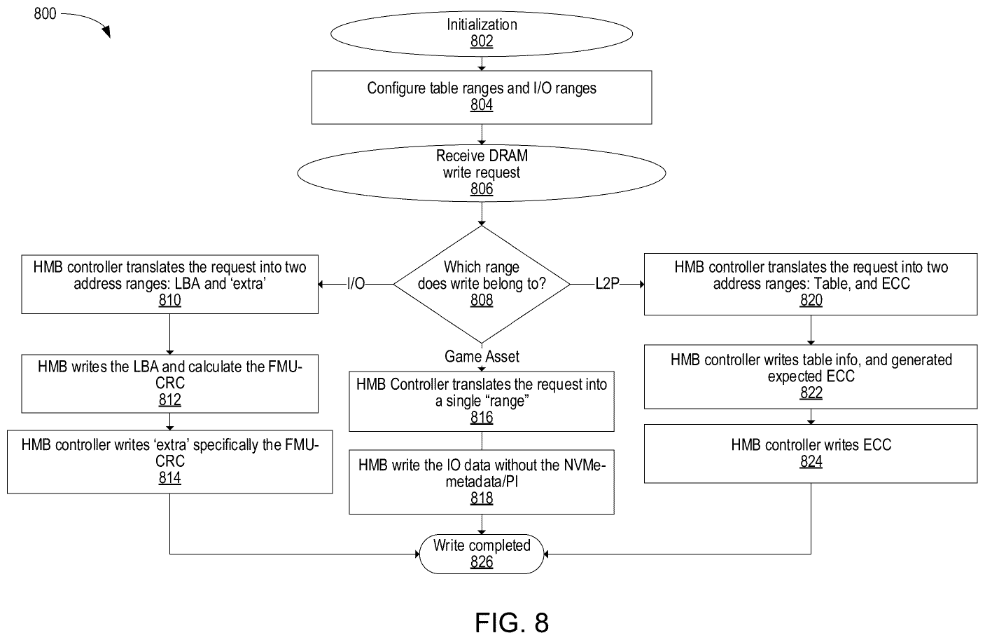

FIG. 8 is a flowchart illustrating a method 800 for a write request to the HMB, according to certain embodiments. For gaming/streaming write requests do not use FMU-CRC or ECC so the information is written to the HMB. For I/O operations (I/O user data) write requests will have to generate FMU-CRC, while L2P tables will need to generate ECC information.

The method 800 begins at block 802. At block 802, initialization beings. At block 804, the HMB controller such as the HMB controller 306 of FIG. 3 configures table ranges and I/O ranges. At block 806, the HMB controller receives a DRAM write request. At block 808, the controller determines which range the write request belongs to. If the HMB controller determines that the write request belongs to I/O user data, then the method 800 proceeds to block 810. If the HMB controller determines that the write request belongs to a game asset, then the method 800 proceeds to block 816. If the HMB controller determines that the write request belongs to the logical to physical (L2P), then the method 800 proceeds to block 820.

At block 810 the HMB controller translates the request into two address ranges: LBA and ‘extra’ which may include metadata. At block 812, the HMB writes the LBA and calculate the FMU-CRC. At block 814, the HMB controller writes the ‘extra’, specifically the FMU-CRC, and the method proceeds to block 826.

At block 816, the HMB controller translates the write request into a single “range”. At block 818, the HMB writes the I/O user data without the NVMe-MD/PI and proceeds to block 826.

At block 820, the HMB controller translates write request into two address ranges: table and ECC. At block 822, the HMB controller writes table info, and generated expected ECC. At block 824, the HMB controller writes ECC and the method 800 proceeds to block 826. At block 826, the write request is completed.

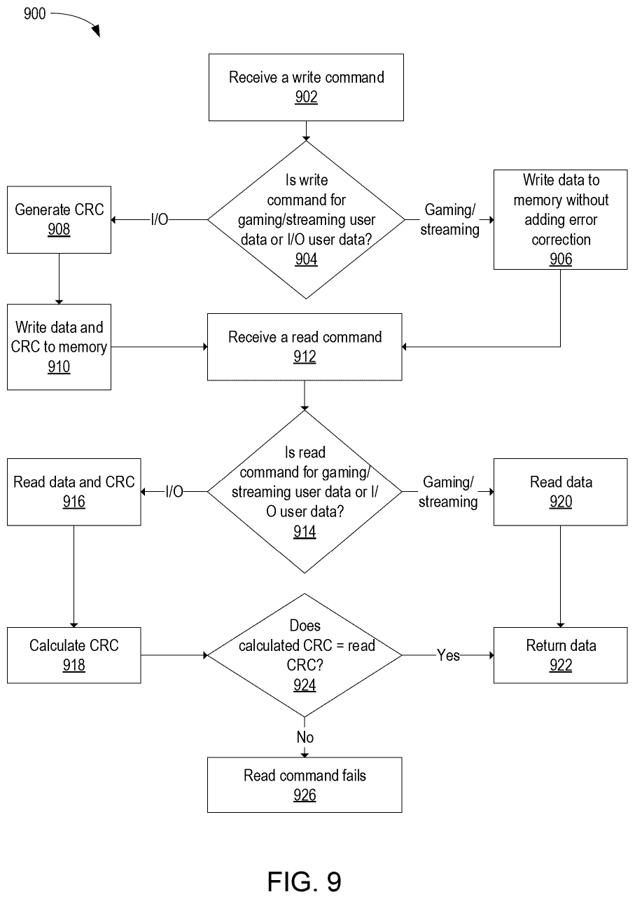

FIG. 9 is a flowchart illustrating a method 900 for a write command and read command for either I/O operations or gaming/streaming operations, according to certain embodiments. The HMB controller such as HMB controller 306 of FIG. 3 will first receive a write command and have to determine whether the write command is that of an I/O operation (I/O user data) or a gaming/streaming operation (gaming/streaming user data). The HMB controller will then write data and CRC information if the write request is an I/O operation or just write data without adding ECC information if the write request is a gaming/streaming operation. Once the HMB controller handles the write operation, a read request will arrive. The HMB controller will then have to determine if the read request is that of an I/O operation of are gaming/streaming operation. The HMB controller will then read data and CRC information for an I/O operation or just read data for a gaming/streaming operation.

The method 900 begins at block 902. At block 902 the HMB controller such as the HMB controller 306 of FIG. 3 receives a write command. At block 904, the HMB controller determines whether the write command is for gaming/streaming user data or I/O user data. If the HMB controller determines the write command is for gaming/streaming user data, then the method 900 proceeds to block 906. If the HMB controller determines that the write command is for I/O user data, then the method 900 proceeds to block 908. At block 906, the HMB controller writes the data to the memory without adding error correction. At the completion of block 906 the method 900 proceeds to block 912. At block 908, the HMB controller generates CRC. At block 910, the controller writes data and CRC to the memory and the method 900 proceeds to block 912.

At block 912, the controller receives a read command. At block 914, the controller determines whether the read command is for gaming/streaming user data or I/O user data. If the HMB controller determines that the read command is for I/O user data, then the method 900 proceeds to block 916. If the HMB controller determines the read command is for gaming/streaming user data, then the method 900 proceeds to block 920. At block 916, the HMB controller reads data and CRC. At block 918, the HMB controller calculates the CRC and the method 900 proceeds to block 924. At block 920, the HMB controller reads data and the method 900 proceeds to block 922. At block 924, the HMB controller determines whether the calculated CRC equals the read CRC. If the HMB controller determines that the calculated CRC equals the read CRC, then the method 900 proceeds to block 922. If the HMB controller determines that the calculated CRC does not equal the read CRC, then the method 900 proceeds to block 926. At block 922, the HMB controller returns the data. At block 926, the read command fails.

Using the existing protection requirement for user-data, or the knowledge that no protection is required at all, instead of always using a dedicated ECC increase the device performance. The HMB-DRAM range and PCIe bandwidth will be saved due to less use of the DRAM for ECC information. In so doing, not only will PCIe bandwidth be saved, but DRAM and host DRAM (e.g., HMB) space will be saved.

In one embodiment, a data storage device comprises: a memory device; and a controller coupled to the memory device, wherein the controller is configured to: configure table ranges and input/output ranges for storage; receive a write request to write data to memory; determine that the write request is for input/output operations; translate the write request into two address ranges, logical block address (LBA) and cyclic redundancy check (CRC); write the LBA to the memory; calculate the CRC; and write the CRC to the memory. The CRC is a flash management unit (FMU) CRC. The memory is dynamic random access memory (DRAM). The DRAM is coupled to a DRAM controller that comprises an arbiter, cache, and direct memory access (DMA). The memory is host memory buffer (HMB) or controller memory buffer (CMB). The input/output operations comprise user data for write cache, user data for XOR recovery, or user data for read look ahead. The controller does not generate error correction code (ECC). The controller is configured to determine whether the data includes metadata and protection information. The controller is configured to generate and inject protection information to the data when not included by a host. The controller is configured to: read the data from memory; calculate a CRC; compare the calculated CRC to a read CRC; and provide the data if the calculated CRC equals the read CRC.

In another embodiment, a data storage device comprises: a memory device; and a controller coupled to the memory device, wherein the controller is configured to: configure table ranges and input/output ranges for storage; receive a write request to write data to memory; determine that the write request is for gaming or streaming operations; translate the write request into a single address range; and write the single address range to the memory, wherein the single address range does not include nonvolatile memory express (NVMe) protection information. The controller is configured to not generate error correction data for the write request. The controller is configured to not add error correction data to the single address range. Determine that the data does not include error correction code (ECC) or protection information. The controller is configured to: provide the data without performing an error check or correction on the data. The determining occurs anywhere within the controller, including the host interface module (HIM), but when the determining occurs outside of the HIM, the (HIM), the information is passed to the HIM.

In another embodiment, a data storage device comprises: means to store data; and a controller coupled to the means to store data, wherein the controller is configured to: issue a write request to write data to the means to store data; write the data to the means for storing data; calculate error corrector code (ECC) for the data; write the calculated ECC to the means for storing data as actual ECC; issue a read request to read the data; calculate an expected ECC for the data; and compare the expected ECC to the actual ECC and write actual ECC. The controller is configured to not deliver the data if the actual ECC and expected ECC do not match. The controller is configured to write translate the write command into two address ranges: table and ECC. The controller is configured to determine whether the write command is for input/output operations, gaming, or tables.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
configure table ranges and input/output ranges for storage;
receive a request to write data to memory or read data from memory;
determine that the request is for input/output operations;
translate the request into two address ranges, logical block address (LBA) and cyclic redundancy check (CRC);
either:
calculate the CRC for a write request; or
read a stored CRC for a read request and compare the translated CRC to either the stored CRC or calculated CRC; and
either:
write the calculated CRC to the memory for write requests; or
determine whether to provide data associated with the read request.

2. The data storage device of claim 1, wherein the CRC is a flash management unit (FMU) CRC.

3. The data storage device of claim 1, wherein the memory is dynamic random access memory (DRAM).

4. The data storage device of claim 3, wherein the DRAM is coupled to a DRAM controller that comprises an arbiter, cache, and direct memory access (DMA).

5. The data storage device of claim 1, wherein the memory is host memory buffer (HMB) or controller memory buffer (CMB).

6. The data storage device of claim 1, wherein the input/output operations comprise user data for write cache, user data for XOR recovery, or user data for read look ahead.

7. The data storage device of claim 1, wherein the controller does not generate error correction code (ECC).

8. The data storage device of claim 1, wherein the controller is configured to determine whether the data includes metadata and protection information.

9. The data storage device of claim 8, wherein the controller is configured to generate and inject protection information to the data when not include by a host.

10. The data storage device of claim 1, wherein the controller is configured to:
read the data from memory for a read request; and
provide the data if the calculated CRC equals the read CRC.

11. A data storage device, comprising:
a memory device; and
a controller coupled to the memory device, wherein the controller is configured to:
configure table ranges and input/output ranges for storage;
receive a write request to write data to memory;
determine that the write request is for input/output range but intended for gaming or streaming operations;
translate the write request into a single address range; and
write the single address range to the memory, wherein the single address range does not include nonvolatile memory express (NVMe) protection information.

12. The data storage device of claim 11, wherein the controller is configured to not generate error correction data for the write request.

13. The data storage device of claim 11, wherein the controller is configured to not add error correction data to the single address range.

14. The data storage device of claim 11, determine that the data does not include error correction code (ECC) or protection information.

15. The data storage device of claim 11, wherein the controller is configured to:
provide the data without performing an error check or correction on the data.

16. The data storage device of claim 11, wherein the determining occurs anywhere within the controller, wherein if the determining occurs outside of a host interface module (HIM), the HIM is informed of the determining.

17. A data storage device, comprising:
means for storing data; and
a controller coupled to the means for storing data, wherein the controller is configured to:
configure table ranges and input/output ranges for storage;
determine read or write requests received are for the table ranges;
either:
issue a write request to write data to the means for storing data, write the data to the means for storing data, calculate error correction code (ECC) for the data, and write the calculated ECC to the means for storing data as actual ECC; or
issue a read request to read the data, calculate an expected ECC for the data; and compare the expected ECC to the actual ECC.

18. The data storage device of claim 17, wherein the controller is configured to not deliver the data if the actual ECC and calculated ECC do not match.

19. The data storage device of claim 17, wherein the controller is configured to write translate the write command into two address ranges: table and ECC.

20. The data storage device of claim 17, wherein the controller is configured to determine whether the write command is for input/output operations, gaming, or tables.
